(19) United States
(12) Patent Application Publication
(10) Pub. No.: US 2005/0172777 A1
(43) Pub. Date: Aug. 11, 2005

(54) Blade for use in slitting a paper or board web

(76) Inventors: Harry Olander, Paippinen (FI); Heikki Fohr, Jarvenpaa (FI); Jari Liimatainen, Tampere (FI); Pekka Siitonen, Lempaala (FI); Mikko Kumpula, Tampere (FI)

Correspondence Address: STIENNON & STIENNON, 612 W. MAIN ST., SUITE 201, P.O. BOX 1667, MADISON, WI, 53701-1667, US

(21) Appl. No.: 10/515,874

(22) PCT Filed: May 26, 2003
(86) PCT No.: PCT/FI03/00401

(30) Foreign Application Priority Data
May 28, 2002 (FI) 20020997

(51) Int. Cl. B27B 13/02

(52) U.S. Cl. 83/835

(57) ABSTRACT

A blade (10) for use in the slitting of a paper or board web has a hub part (11) and a blade part (15). The blade part (15) is releasably secured by means of securing members (12, 13) to the hub part (12). The securing members (12, 13) are formed so as to distribute and/or maintain the axial load enabling the joint to withstand high circumferential speeds.

### CROSS REFERENCES TO RELATED APPLICATIONS

This application is a U.S. national stage application of International App. No. PCT/FI03/00401, filed May 26, 2003, and claims priority on Finnish Application No. 20020997, Filed May 28, 2002, the disclosure of which is incorporated by reference herein.

### STATEMENT AS TO RIGHTS TO INVENTIONS MADE UNDER FEDERALLY SPONSORED RESEARCH AND DEVELOPMENT

Not applicable.

### BACKGROUND OF THE INVENTION

The invention relates to a blade for use in the slitting of a paper or board web, which blade comprises a hub part and a blade part.

Slitting of a paper or board web is carried out in paper or board machines, for example, in connection with the slitting of a paper web into component webs with a slitter-winder and in connection with trimming taking place in different parts of the paper machine. The publication Winding by Kenneth G. Frye (TAPPI PRESS, 1990, chapter VIII “Slitting Function” (pp. 75-94)) deals with prior art relating to slitting and blades used in slitting. A pair of blades comprising a lower blade and an upper blade is conventionally used in slitting. In most cases the upper blade is a disc blade made in one piece. A disc blade made in one piece is known from prior art, which blade is to some extent flexible and in which the flexibility has been brought about by means of a very thin steel structure, which also withstands rather high circumferential speeds, e.g. 2000 m/min. Blades in which the cutting edge is a separate ring are also known from prior art, but the problem related to them is that the joint does not withstand the high circumferential speeds required by modem slitter-winder operation, e.g. circumferential speeds of 3000 m/min or more, since, in these applications, the ring is usually attached to the core of a shaft with a Seeger circlip and, as the circumferential speeds rise above 2000 m/min, circular support members expand and slip out of their grooves due to centrifugal force. Prior art blades have not allowed for an optimal solution between flexibility and the ability to withstand high circumferential speeds. That is to say that prior art blades are known which are flexible but which cannot be used when high circumferential speeds are required. On the other hand, blades that withstand high circumferential speeds but are inflexible are also known from prior art. The blades wear in slitting, and the blade costs become high when using expensive blade materials difficult to machine. Also, as the blades wear, they have to be ground from time to time in order to maintain the cutting properties.

Where slitting takes place blade noise also occurs mostly due to vibration of the upper blade. The dynamic properties of a conventional upper blade are such that it has several natural vibration modes in an audio range and these vibrations are efficiently reflected as airborne noise causing the upper blade to “resonate”, which causes noise problems. Furthermore, the vibration itself causes problems in connection with slitting and it also makes the blades wear unnecessarily quickly, because the vibration generates an uneven contact force between the blades.

### SUMMARY OF THE INVENTION

It is an object of the invention to provide a blade for use in connection with the slitting of a paper or board web, by means of which blade the problems described above are eliminated or at least minimized.

It is an object of the invention to provide a blade of low manufacturing costs.

A further object of the invention is to provide a blade which does not wear as quickly as prior art arrangements.

An object of the invention is to provide a blade for use in connection with the slitting of a paper or board web, the vibration and noise caused by which blade is eliminated or at least minimized.

To achieve the afore-mentioned objects and those that come out later the blade according to the invention is mainly characterized in that a blade part is secured by means of axial securing members to a hub part and that the securing members comprise a part distributing the axial load substantially evenly on a blade ring and parts or shapes maintaining the axial load, the securing members being formed so as to substantially distribute and/or maintain axial load enabling the joint to withstand high circumferential speeds, and that the spring constant of the blade is 500-3000 N/mm measured such that the cutting edge is supported in the axial direction and the blade arrangement is loaded in the axial direction from the center in a deflection range of 0-0.5 mm.

According to the invention a blade ring and the joint between the blade ring and the hub are secured to the hub of the blade, in which joint securing members distributing and/or maintaining the axial load are used, preferably axial securing members. In the invention the term “securing members” refers, in this description, to various securing parts and the like and also to various securing shapes. The securing arrangement according to the invention allows the blade ring to turn about an axial ring thus allowing the cutting edge to deflect in the axial direction, whereby a flexible blade structure can be provided. According to a further advantageous feature of the blade according to the invention the spring constant of the blade according to the invention is 500-3000 N/mm. The blade according to the invention advantageously has a rigid hub and, in the axial direction, an appropriately flexible cutting edge, providing for very good blade properties in view of obtaining flexibility and ability to withstand circumferential speed. The blade withstands high circumferential speeds, since centrifugal force does not tend to release the securing members.

Furthermore, when a narrow, wear-resistant, thin blade ring is used in connection with the invention, the structure is less expensive than arrangements known from prior art. The blade ring according to the invention is 0.5 mm-8 mm, most appropriately 1.5 mm-4 mm thick. The vibration properties of the structure according to the invention are more advantageous than those of the existing structure, because the joint damps vibration. The wear-resistance of the blade ring is good, since the vibration causing wear and cracking of the blade has been diminished. The blade according to the invention pays special attention to the fact that although, during cutting, the blade may vibrate to some extent, the vibration must not cause vibration of the surrounding air, because it would cause noise nuisances.

According to a further advantageous characteristic, the securing of the blade ring according to the invention to the hub structure can be released, if need be, making the changing of the blade ring easy and simple, when necessary. The securing is flexible and damps vibration, because micro movement occurs in the joint if the blade vibrates. The core material has preferably been selected so that it damps vibration and is less expensive and easier to machine than arrangements known from prior art. According to the invention the wearing blade ring is disposed on the outer circumference of the blade and is easy to replace. The material of the blade ring is advantageously tool steel and the core material is advantageously, e.g. cast iron or steel. This way, in the invention, cost savings can be obtained in respect of the manufacturing costs, since expensive material difficult to machine has only been used in the parts where it is required.

The blade according to the invention is suitable for use in connection with blades for slitting paper or board, particularly in connection with straight and disc-shaped blades, e.g. in connection with the blades of a slitter-winder or with trimming blades.

The invention will now be described in more detail with reference to the figure of the accompanying drawing, to the details of which the invention is, however, by no means intended to be confined.

### BRIEF DESCRIPTION OF THE DRAWINGS

FIG. 1 shows a blade application known from prior art.

FIG. 2 schematically shows an advantageous exemplifying embodiment of the invention.

### DESCRIPTION OF THE PREFERRED EMBODIMENTS

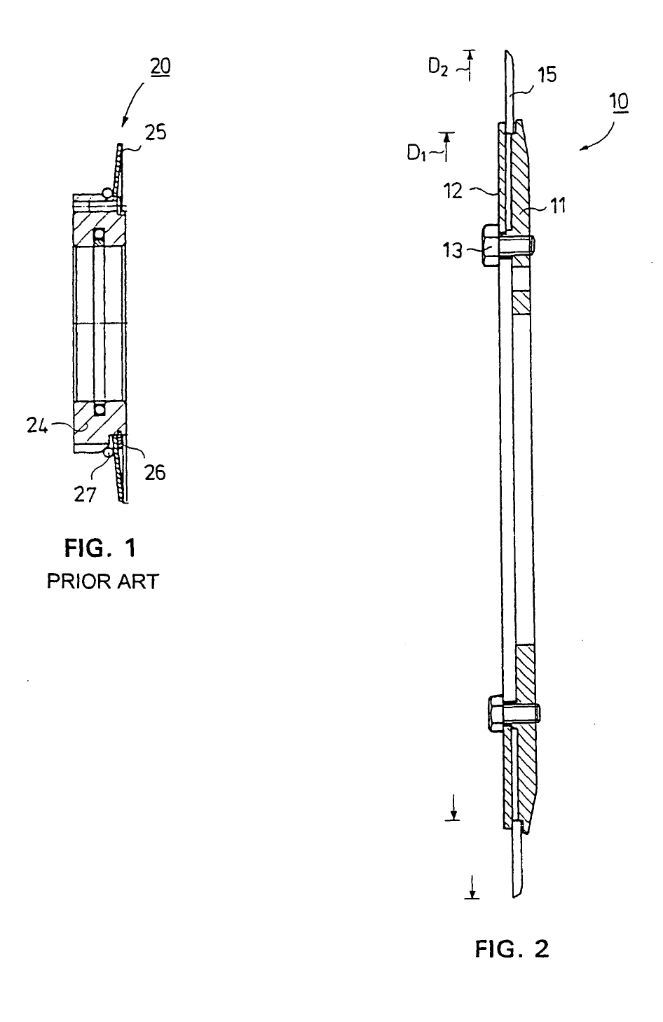

FIG. 1 shows a prior art blade 20, in which a blade part 25 is secured to a hub 24 of a shaft by means of a Seeger circlip 26 and a helical spring 27.

In the schematic exemplifying embodiment of the invention shown in FIG. 2 a blade ring 15 is secured to a hub structure 11 of a blade 10 by means of securing members 12 and 13 and a joint is formed by the securing members or shapes 12, 13 so that the securing is flexible, enabling it to danip vibrations and thus blade noise as well. The securing members of the blade ring 15 are formed of the following parts; the part 12 distributing axial force evenly on an inner circumference of the blade, the part or shape 13 maintaining the axial force. The distributing part is spring steel, preferably a belleville spring. The blade is most appropriately 1.5-4 mm thick and the material of the blade ring 15 is tool steel, e.g. powder metallurgical tool steel and the hub material is cast iron or steel. The inner diameter D₁ of the blade ring 15 is 100-200 mm, advantageously 130-180 mm and most appropriately 140-165 mm and the outer diameter D₂ is 130-220 mm, advantageously 175-205 mm.

Some test results relating to two different spring constants of a blade material known from prior art and the spring constant of the blade according to the invention are disclosed in Table 1.

TABLE 1

| | K i.e. spring constant |
|---|---|
| Prior art | K = 4.1 kN/mm |
| Example 1 | |
| Prior art | K = 4.3 kN/mm |
| Example 2 | |
| Blade according to the invention | K = 1.7 kN/mm |

These test results have been measured such that the entire cutting edge has been supported in the axial direction and the blade arrangement has been loaded in the axial direction from the center and the results have been obtained in a deflection range of 0-0.5 mm.

The following table 2 presents results obtained in a test:

TABLE 2

| | |
|---|---|
| | Blade according |
| Prior art blade | to the invention |

| | | | | |
|---|---|---|---|---|
| Life time | 250 | hours | 600 | hours |
| Circumferential speed | 2000 | m/min | over 2000 | m/min |

The blade part according to the invention is preferably made of tool steel the carbon content of which is at least 1 percent by weight and in which the combined vanadium and/or molybdenum and/or niobe and/or wolfram and/or chrome content is 10-25 percent by weight of the material.

1. A blade (10) for use in the slitting of a paper or board web comprising a hub part (11) and a blade part (15), characterized in that the blade part (15) is secured by means of securing members (12, 13) to the hub part (11) such that the securing members (12, 13) are formed so as to substantially distribute and/or maintain axial load enabling the joint to withstand high circumferential speeds.

2. A blade according to claim 1, characterized in that the securing members (12, 13) comprise a part (12) distributing the axial load substantially evenly on a blade ring and parts or shapes (13) maintaining the axial load.

3. A blade according to claim 1, characterized in that the blade part (15) is made powder metallurgically of tool steel whose carbon content is at least 1 percent by weight and whose combined vanadium and/or molybdenum and/or niobe and/or wolfram and/or chrome content is 10-25 percent by weight of the material.

4. A blade according to claim 1, characterized in that the hub part (11) of the blade is made of cast iron or steel material.

5. A blade according to claim 1, characterized in that the blade part (15) is 0.5 mm-8 mm, most appropriately 1.5 mm-4 mm thick.

6. A blade according to claim 1, characterized in that the inner diameter (D₁) of the blade part (15) is 100-200 mm, advantageously 130-180 mm and most appropriately 140-165 mm and the outer diameter (D₂) is 130-220 mm, advantageously 175-205 mm.

7. A blade according to any one of claims 1-6, characterized in that the spring constant of the blade is 500-3000 N/mm measured such that the cutting edge is

8. A blade arrangement for use in the slitting of a paper or board web comprising:
a hub part having a center part;
a blade ring, having a cutting edge, wherein the blade ring is mounted to the hub part, the blade ring defining an axis and an axial direction; and
axial securing members which secure the blade ring to the hub part with an axial load to define a joint between the blade ring and the hub part, wherein the securing members comprise a part distributing the axial load substantially evenly on the blade ring, and parts maintaining the axial load;
wherein the joint is arranged to withstand circumferential speeds of 2000 m/min or more; and
wherein the blade arrangement has a spring constant of 500-3000 N/mm measured by supporting the cutting edge in the axial direction and loading the blade arrangement in the axial direction from the center part in a deflection range of 0-0.5 mm.

9. The blade arrangement of claim 8, wherein the blade ring is made powder metallurgically of tool steel whose carbon content is at least 1 percent by weight and whose combined vanadium and/or molybdenum and/or niobe and/or wolfram and/or chrome content is 10-25 percent by weight of the material.

10. The blade arrangement of claim 8 wherein the hub part is cast iron or steel.

11. The blade arrangement of claim 8, wherein the thickness of the blade ring is from 0.5 mm to 8 mm.

12. The blade arrangement of claim 11 wherein the thickness of the blade ring is from 1.5 mm to 4 mm.

13. The blade arrangement of claim 8, wherein the blade ring has an inner diameter of 100-200 mm and an outer diameter of 130-220 mm.

14. The blade arrangement of claim 13 wherein the blade ring inner diameter is from 130 mm to 180 mm.

15. The blade arrangement of claim 14 wherein the blade ring inner diameter is from 140 mm to 165 mm.

16. The blade arrangement of claim 13 wherein the blade ring outer diameter is from 175 mm to 205 mm.

17. The blade arrangement of claim 8 wherein the blade ring is releasably secured to the hub part.

18. The blade arrangement of claim 8 wherein the blade arrangement is made of parts made of materials having different types of material properties.

19. A blade arrangement for use in the slitting of a paper or board web comprising:
a hub part having a center part;
a blade ring having a cutting edge, the blade ring being mounted to the hub part, the blade ring defining an axis and an axial direction; and
a belleville spring formed of spring steel which engages the blade ring and distributes axial force on the blade ring, a joint being defined between the blade ring and the hub part;
a connector extending between the belleville spring and the hub part and maintaining an axial force on the belleville spring; and
wherein the blade arrangement has a spring constant of 500-3000 N/mm measured by supporting the cutting edge in the axial direction and loading the blade arrangement in the axial direction from the center part in a deflection range of 0-0.5 mm.

20. The blade arrangement of claim 19, wherein the blade ring is composed of powder metallurgically formed tool steel whose carbon content is at least 1 percent by weight and whose combined vanadium and/or molybdenum and/or niobe and/or wolfram and/or chrome content is 10-25 percent by weight of the material.

21. The blade arrangement of claim 19 wherein the hub part of the blade is made of cast iron or steel material.
